(19) United States
(12) Patent Application Publication
(10) Pub. No.: US 2003/0124242 A1
(43) Pub. Date: Jul. 3, 2003

(54) Capsule comprising at least mineral coating consisting of a single chemical compound and a core comprising at least a polyhydroxylated compound

(76) Inventors: Jean-Claude Kiefer, Blaincourt Les Precy (FR); Sophie Vaslin, Saint-Cloud (FR)

Correspondence Address: John A Shedden, Rhodia Inc, Intellectual Property Department, 259 Prospect Plains Road CN7500, Cranbury, NJ, 08512-7500, US

(21) Appl. No.: 10/148,790

(22) PCT Filed: Dec. 6, 2000
(86) PCT No.: PCT/FR00/03405

(30) Foreign Application Priority Data
Dec. 7, 1999 (FR) 99/15405

(51) Int. Cl. A23L 1/00

(52) U.S. Cl. 426/658; 426/89

(57) ABSTRACT

The invention concerns a capsule comprising at least a mineral coating (E) and a core (N) comprising at least a polyhydroxylated compound (P), each coat essentially consisting of a single mineral compound. The mineral coating (E) advantageously consisting of a single mineral compound layer. The invention also concerns a method for obtaining said capsules and their use.

A subject matter of the present invention is capsules comprising at least an inorganic shell (E) and a core (N) which comprises at least one polyhydroxylated compound (P), each shell being composed essentially of a single inorganic compound.

Another subject matter of the invention is the process for the preparation and the use of these capsules.

In many technical fields, in particular in the farm-produce industry, attempts are being made to obtain compositions of “core-shell” type composed of a shell, within which at least one material is immobilized or encapsulated.

In compositions of this type, the active material(s) can be isolated, definitively or temporarily, from their surrounding medium, in particular with the aim of protecting them and/or of delaying and/or of controlling their release.

In the context of the present invention, the terms “controlled” release and “delayed” release can be defined in the following way:

the term “controlled” release means a release which can be triggered by a factor external to the system, which can also be referred to as the “trigger”, such as the temperature, the pH or the pressure, this release being independent of the time;

in other words, the choice is made of precisely at what moment and under what conditions it is desired for the release to take place;

the term “delayed” release means a release which takes place as a function of time with reasonably slow kinetics and without the involvement of external factors;

in other words, the release conditions are predetermined so that the release begins as soon as the “core-shell” composition is in the medium with reasonably fast kinetics, without it being possible to control the release a posteriori.

These “core-shell” compositions are particularly advantageous when attempts are being made, for example, to mask the taste of a material, to delay and/or to control the thickening and/or gelling action of a material or to preserve the structural and functional integrity of a material.

Mention may be made, as an example illustrating the importance of this type of composition, of the encapsulation of dietary fiber.

It is now generally accepted in the minds of consumers that dietary fiber has nutritional properties and is of some advantage in the prevention of certain pathologies, in particular digestive abnormalities, abnormalities in the metabolism of lipids (hypocholesterolemic effect) and abnormalities in the metabolism of glucides (the case of diabetics).

Thus, their incorporation in foods in a sufficient amount makes it possible to increase the daily supply of fiber and thus to prevent the abovementioned pathologies.

Dietary fiber, which is composed of polyhydroxylated compounds, can be chosen, for example, from celluloses, hemicelluloses, pectins, galactomannans, guars, β-glucans, lignins or algal polysaccharides. Dietary fiber is naturally present in cereals, fruits and vegetables.

However, because of its nature, the incorporation of this fiber in an aqueous medium is not without disadvantage.

This is because, in an aqueous medium, some forms of soluble fiber, such as pectins or guars, already result, at low concentration, in solutions with high viscosities. Other forms of insoluble fiber, such as guars, celluloses or β-glucans, form three-dimensional networks which swell considerably in an aqueous medium.

It is thus difficult, indeed even impossible, to incorporate sufficient amounts of fiber in food formulations without leading to a significant modification in the Theological behavior of these formulations.

In such a case, recourse to “core-shell” compositions, also referred to as “capsules”, seems essential.

When a temporary encapsulation of the active material is desired, the parameters which will result in the “destruction” of the shell and thus in the “release” of said material into the medium are preferably determined prior to the encapsulation.

These parameters will depend essentially on the chemical nature of the material constituting the shell but can also depend on its homogeity in terms of chemical composition.

The nature of the material chosen is important as it has to make possible the “controlled” release within the meaning defined above while remaining compatible with the use which will be made of the capsules. For example, in the area of food, said material must additionally satisfy certain requirements, in particular in terms of nontoxiclty, of texture and of Theological, organoleptic and visual properties.

As regards the chemical homogeneity of the shell, it has been found that the more homogeneous the shell in its chemical composition, the easier it is to specifically identify the external conditions for the release of the encapsulated material.

“Homogeneity in terms of chemical composition” of the shell is understood to mean a shell which is composed essentially of a single chemical compound. Furthermore, the shell of each of the capsules is composed essentially of the same single chemical compound.

The term “compound” denotes an assembly formed by several elements.

In the context of the present invention, the shell is composed essentially of a single inorganic compound, that is to say that at least 90% of said shell is composed of just one inorganic compound.

An aim of the invention is to provide compositions of “core-shell” type, also known as capsules, for which the parameters of release and of diffusion of the material can be determined and controlled with greater accuracy.

Another aim of the invention is to provide capsules, the shell of which is temporary in the sense that it makes possible a controlled release of the core under the action of a “trigger”.

Another aim of the invention is to provide capsules which exhibit good dispersibility in the media into which they are introduced.

Another of the aims of the invention is to provide capsules which have a shell which is insoluble in the phases into which they are introduced and which do not significantly modify the rheology of the phases into which they are introduced, whereas the compound of the core, if it were alone, would modify it.

The effectiveness of the controlled release is provided by the homogeneity of the shell of the capsules. The presence of a single inorganic compound makes it possible to obtain great accuracy of the controlled release. The appropriate type of “trigger”, such as, for example, the pH, can be chosen according to the choice of the inorganic compound.

These aims and others are achieved by the present invention, a subject matter of which is capsules comprising at least an inorganic shell (E) and a core (N) which comprises at least one polyhydroxylated compound (P), each shell being composed essentially of a single inorganic compound.

The invention additionally relates to a process for the preparation in the solid phase of these capsules.

Finally, the invention relates to the use of these capsules.

Other characteristics, details and advantages of the invention will become even more fully apparent on reading the description which will follow and the various concrete but nonlimiting examples intended to illustrate it.

The first aspect of the present invention is a capsule comprising at least an inorganic shell (E) and a core (N) which comprises at least one polyhydroxylated compound (P), each shell being composed of a single inorganic compound.

The inorganic compound constituting the shell (E) is chosen from alkaline earth metal phosphates, alkaline earth metal carbonate or basic carbonate, transition metal basic carbonate, alkaline earth metal or transition metal sulfates, alkaline earth metal borates, alkaline earth metal halides or precipitated silicas.

The alkaline earth metals are advantageously chosen from magnesium and calcium.

The transition metals are preferably chosen from aluminum and iron.

The halogen atoms can be chosen from bromine, chlorine and iodine.

Mention may in particular be made, as alkaline earth metal phosphates, of mono-, di- or tricalcium phosphates, triphosphates or pyrophosphates.

Precipitated silica is understood to mean here a silica obtained by precipitation from the reaction of an alkali metal silicate with an acid, generally an inorganic acid, at an appropriate pH of the precipitation medium, in particular a basic, neutral or only slightly acidic pH; the silica can be prepared in any way (addition of acid to a silicate vessel heel, complete or partial simultaneous addition of acid or of silicate to a vessel heel formed of water or of silicate solution, and the like) and the method of preparation of the silica is chosen according to the type of silica which it is desired to obtain; on conclusion of the precipitation stage, a stage of separation of the silica from the reaction medium is generally carried out according to any known means, filter press or vacuum filter, for example; the filtration cake is thus collected and is washed, if necessary; this cake can, optionally after breaking up, be dried by any known means, in particular by atomization, and can then optionally be milled and/or agglomerated.

Mention may be made, as such, of, for example, the range of Tixosil® products sold by Rhodia.

The particles of the inorganic compound generally have a size of between 0.1 and 100 microns, advantageously between 0.1 and 50 microns.

The size of the particles is determined conventionally by laser particle size determination, for example using Coulter® LS 230.

According to a preferred embodiment of the invention, the capsules are composed essentially of just one layer of particles of single inorganic compound. This characteristic contributes positively to the determination and the control of the parameters for release and diffusion of the material. More particularly, it contributes to the good dispersibility of the capsules.

The inorganic shell (E) represents between 0 exclusive and 50%, advantageously between 2 and 40% and preferably between 5 and 30%, by weight with respect to the total weight of the capsule.

The capsules are also composed of a core (N) which comprises at least one polyhydroxylated compound (P).

The polyhydroxylated compound (P) is advantageously a polysaccharide which can be chosen from threose, erythrose, arabinose, xylose, ribose, deoxyribose, rhamnose, fucose, glucosamine, galactosamine, N-acetylglucosamine, N-acetylgalactosamine, starches, amylopectin, amylose, araban, alginates, carrageenans, cellulose, chitosan, chondroitin sulfate, dextran, dextrin, fructosan, galactan, mannans, such as, in particular, galactomannans, gum arabic, pectins, gum ghatti, galactoside, glucan, glycan, glycogen, hemicellulose, hyaluronic [lacuna], inulin, lamarinarin, levan, mucoitin sulfate, nigeran, pentosan, polydextrose or xylan.

More particularly, the polyhydroxylated compound (P) is chosen from guars, pectins, celluloses and β-glucans.

The polyhydroxylated compounds (P) may be alone or as a mixture in the core (N).

In the continuation of the account, the term “hydroxylated compound” will be employed to denote both a single polyhydroxylated compound and a mixture of polyhydroxylated compounds.

The particles of the compound (P) preferably exhibit a size of between 1 to 500 microns, advantageously between 2 and 200 microns, preferably between 2 and 80 microns.

The core (N) comprising at least one polyhydroxylated compound (P) represents between 50% and 100% exclusive, advantageously between 60 and 98% and preferably between 70 and 95%, by weight with respect to the total weight of the capsule.

According to a specific embodiment of the invention, the polyhydroxylated compound (P) can be partially substituted by a substance (S) chosen from flavorings, essential oils, colorants, film-forming substances, such as depolymerized guar or arabinoxylan, or substances which prevent the formation of foams, such as polyethoxylated oils derived from palm oil, soybean oil, castor oil, rapeseed oil, corn oil or sunflower oil.

In this embodiment, the contents of the core, namely the total amount of the polyhydroxylated compound (P) and of substance (S), are between 50% and 100% exclusive, advantageously between 60 and 98% and preferably between 70 and 95%, by weight with respect to the total weight of the capsule.

The controlled release of the contents of the core into the medium, as mentioned above, can be accomplished by the destruction of the shell.

This destruction can result in particular from the dissolution of the shell by variation in pH.

In the context of the invention, the shell (E) exhibits the advantage of being sensitive to pH.

Thus, the variation in pH necessary for the destruction of the shell (E) will depend on the nature of the constituent material of the shell and on the application which will be made of the capsules.

According to a preferred form of the invention, the pH for destruction is less than 7. It is preferably less than 5 and more preferably less than 4.

In the capsules according to the invention, the inorganic shell (E) has the advantage of efficiently protecting the contents of the core, that is to say the polyhydroxylated compound (P) and, if appropriate, the substance (S), of conveying them into a given medium and, finally, of releasing them.

This phenomenon of release can be characterized, for example, by particle size measurements of the contents of the released core, of viscosity of the medium or of turbidity of the medium.

Another subject matter of the invention is a process for the preparation in the solid phase of capsules.

The encapsulation of the material is carried out conventionally by the wet route. This type of process consists in forming an inorganic shell, after precipitation of the salts and chemical reaction at the interface of what will constitute the core. In this type of process, the control of the degree of homogeneity in terms of the chemical composition of the shell within the meaning of the invention can prove to be very difficult, indeed even in some cases impossible. Very often, the shell formed by precipitation is composed of a mixture of salts. For example, in order to obtain a shell of calcium phosphate type, generally calcium chloride (CaCl₂) is reacted with sodium phosphate (sodium orthophosphate NaH₂PO₄.2H₂O). After precipitation, the expected salt, which is brushite (CaHPO₄.2H₂O), is indeed obtained but also mixed salts, such as 2CaHPO₄.2Ca₃(PO₄)₂.5H₂O or 2CaHPO₄.5Ca₃(PO₄)₂.Ca(OH)₂. For this reason, the behavior of the shell, and more particularly its dissolution by pH lowering, will be modified, the determination and the use of the optimum conditions for optimum dissolution of the shell will be more difficult.

To date, to the knowledge of the Applicant Company, there does not exist a process for encapsulation by a “wet route” which results in the formation of a shell composed of a single chemical compound.

The capsules according to the present invention are prepared by a process by the “dry route”, that is to say in the absence of water, of solvents or any other liquid medium.

The process of the present invention has the advantage of making it to possible to start from the desired inorganic compound and to obtain a shell composed essentially of said compound. Furthermore, the inorganic compound constituting the shell (E) will exhibit the same crystalline phase as that of the inorganic compound initially employed in the process.

Because of its chemical homogeneity in terms of composition, the dissolution (trigger for release) of the shell will be governed only by the chemistry of the inorganic compound constituting it.

This process additionally has the advantage of being simpler and more economic. This is because the stage of drying the capsules, a stage which is essential in an encapsulation by the wet route, is dispensed with in a process according to the invention.

In this process, the starting materials used, namely the inorganic compound constituting the shell (E), the compound (P), and, if appropriate, the substance (S), are involved in the solid state, which makes it possible to considerably restrict the losses of starting materials. In other words, virtually all the amount of starting material charged is converted into capsules.

Thus, the capsules according to the invention are prepared by a process in which

(i) a mixture of particles constituting the core (N) and that constituting the shell (E) is formed, said particles being in the solid state,

(ii) said mixture is subjected to impact forces with an impact rate of between 30 and 100 m/sec for a time which is sufficiently long for the particles constituting the shell (E) to cover the particles constituting the core (N),

(iii) the capsules (C) thus obtained are subsequently recovered.

An important criterion of this process is to respect the particle size ratio of the size of the particles constituting the shell (E) to that of the particles constituting the core (N). This ratio is advantageously at least ⅕, preferably at least 1/10.

More particularly, the particles of the inorganic compound constituting the shell (E) exhibit a size of between 0.1 and 50 microns, advantageously between 0.1 and 10 microns and preferably between 0.1 and 5 microns.

Advantageously, the particles of the compound (P) and, if appropriate, of the substance (S) exhibit a size of between 1 to 500 microns, advantageously between 2 and 200 microns, preferably 2 and 80 microns.

Another advantage of this process for the preparation of capsules by the “dry route” (in the solid state) is that, after encapsulation, each particle essentially retains its initial size. In other words, if r is regarded as the mean radius of the particles' of the core and r′ is regarded as the mean radius of the particles constituting the shell, the mean radius of the capsules will be equal to r+2r′. As it is known that the value of r is much greater than that of r′, the size of the capsules can then be regarded as corresponding substantially to that of the core.

In addition to the ratio of the size of the particles of the shell to that of the core, the key parameters for succeeding in preparing the capsules according to the invention are the time necessary for carrying out the coating and the control of the temperature.

The control of the temperature is important in preventing any local overheating capable of resulting in undesirable side reactions (such as, for example, the complete dehydration of the polysaccharide). It can be carried out, for example, using a jacketed cooling device.

These parameters have to be adjusted according to the nature of the particles which coat and those which are coated.

The process according to the invention is advantageously carried out batchwise.

The capsules obtained are finally recovered as is, without the need to resort to additional stages of purification, drying, and the like.

This process can be carried out in any reactor which makes possible encapsulation by the dry route.

The process according to the invention can be implemented by any type of device which, under the effect of the impact and/or shear forces, makes it possible for the fine particles in the solid state to encapsulate the large particles in the solid state with a sufficient impact rate. Of course, in this type of device and for optimum encapsulation, it is important to respect a large particles/fine particles size ratio varying from 10 to 100, indeed even more.

Thus, systems composed of a chamber inside which a rotor can be placed in motion can be used from the point when the energy contributed by this rotor within said chamber is sufficient for the small particles to “effectively” encounter the larger particles.

Mention may be made, by way of this device, of, for example, a device of “Nara Hybridizer NHS-0” type sold by Nara Machinery Co. Ltd, Zweign. Europa, or a device of “Mechanofusion System” type sold by Hosokawa.

Another aspect of the invention relates to the use of the capsules according to the invention in the field of food, cosmetics, detergency, pharmaceuticals or construction.

A more particular subject matter of the invention is the use of the capsules in the food field, in particular as adjuvant, for example in energizing drinks, dietetic drinks, meal substitutes, and the like.

The compositions (C) of the invention have the advantage of being able to be used at concentrations greater than those of the prior art and more particularly greater than 10 g/l.

The final subject matter of the invention is food formulations comprising capsules according to the invention.

The following example illustrates the invention without, however, limiting its scope thereof.

### EXAMPLES

### Example 1

Preparation of Capsules With a Shell Composed of Calcium Phosphate and a Core Comprising Guar

Reference of the Products Used

Native guar: Mw=2 000 000 g/mol; particle size of the powder: 32 microns

Hydroxylapatite: Ca₃(PO₄)₂.2CaOH from Prolabo; particle size of the powder: 1.5 microns

Operating Conditions

Device: Nara Hybridizer NHS-0 from Nara Machinery Co. Ltd., Zweign. Europa

Mass of guar=24 g

Mass of phosphate=6 g

Temperature of the jacket=15° C.

Rotational speed of the rotor=8 000 rev/min

Duration of the reaction=2 min

Yield of the encapsulation=90%

Characterization of the Capsules:

The capsules obtained are characterized by the method described below.

a) Quantification of the percentage by mass of water to the powder by determination of the solids content (by drying the powder at 110° C. for 20 min);

b) Determination of the amount of overlaid phosphate salt with respect to the amount of guar by loss of ignition:

the sample to be quantitatively determined is placed for 4 h 30 in a furnace at 900° C. Under these conditions, the polysaccharide is calcined whereas the salt is unaffected.

By methods a) and b), it is possible to determine the exact phosphate salt/polysaccharide ratio by mass: 20% of phosphate salts with respect to the polysaccharide.

c) Laser particle size determination (Coulter LS 230): d=33 microns.

d) Observation of the morphology of the sample using secondary electrons (Transmission microscopy) and topographic observation of the sections obtained by ultramicrotomy.

Transmission microscopy makes it possible to observe the presence of small inorganic particles on the surface of the guar, homogeneously covering the surface of the latter.

By using the electrons backscattered on the sections obtained by ultramicrotomy, the contrast obtained makes it possible to distinguish the phosphate compound which coats the guar.

Applicational Test: Viscometery

The object of this coating is to be able to disperse the guar particles encapsulated by the calcium triphosphate without rendering the medium viscous, the test consists in confirming that the guar is well protected from the surrounding medium and that it does not result in an increase in the viscosity of the medium.

For this, the polysaccharide (1% on the basis of the solids content in deionized water) is poured into the water with gentle stirring (55 mm deflocculating paddle, stirring speed of 300 rev/min, for 15 min)).

The pH of the dispersion is of the order of 6.

The viscosity is determined using a Brookfield rotational viscometer (LVT; 6 rev/min).

While a 0.8% guar solution (corresponding to the amount of guar in the 1% capsules) results in a viscosity of the order of 4 000 mPa s under these conditions, the encapsulated polysaccharide only results in a viscosity of the order of 30 mPa s. This value remains constant, even after 24 h.

In order to release the polysaccharide, a few drops of concentrated HCl are added to the dispersion in order to bring the pH to 2.

Stirring is maintained for 30 min and then the viscosity is determined: it amounts to 3 000 mPa s. After 24 [lacuna], it changes to 3 500 mPa s.

### Example 2

Preparation of Capsules With a Shell Composed of Calcium Phosphate and a Core Comprising Starch

Reference of the Products Used:

Corn starch: particle size of the powder: 10 microns

Brushite: CaHPO₄ from Prolabo; particle size of the powder: 1 micron

Operating Conditions

Device: Nara Hybridizer NHS-0 from Nara Machinery Co. Ltd., Zweign, Europa

Mass of starch=24 g

Mass of phosphate=6 g

Temperature of the jacket=15° C.

Rotational speed of the rotor=8 000 rev/min

Duration of the reaction=3 min

Yield of the encapsulation=95%

Characterization of the Capsules:

The capsules obtained are characterized by the method described below.

a) Quantification of the percentage by mass of water to the powder by determination of the solids content (by drying the powder at 110° C. for 20 min);

b) Determination of the amount of overlaid phosphate salt with respect to the amount of starch by loss of ignition:

the sample to be quantitatively determined is placed for 4 h 30 in a furnace at 900° C. Under these conditions, the polysaccharide is calcined whereas the salt is unaffected.

By methods a) and b), it is possible to determine the exact exact phosphate salt/polysaccharide ratio by mass: 20% of phosphate salts with respect to the polysaccharide.

c) Laser particle size determination (Coulter LS 230): d=11 microns.

d) Observation of the morphology-of the sample using secondary electrons (Transmission microscopy) and topographic observation of the sections obtained by ultramicrotomy.

Transmission microscopy makes it possible to observe the presence of small inorganic particles on the surface of the guar, homogeneously covering the surface of the latter.

By using the electrons backscattered on the sections obtained by ultramicrotomy, the contrast obtained makes it possible to distinguish the phosphate compound which coats the starch.

1. A capsule comprising at least an inorganic shell (E) and a core (N) which comprises at least one polyhydroxylated compound (P), each shell being composed of a single inorganic compound.

2. The capsule as claimed in claim 1, characterized in that the inorganic compound constituting the inorganic shell (E) is chosen from alkaline earth metal phosphates, alkaline earth metal carbonate or basic carbonate, transition metal basic carbonate, alkaline earth metal or transition metal sulfates, alkaline earth metal borates, alkaline earth metal halides or precipitated silicas.

3. The capsule as claimed in claim 2, characterized in that the alkaline earth metals are chosen from magnesium and calcium.

4. The capsule as claimed in any one of claims 1 to 3, characterized in that the transition metal is iron.

5. The capsule as claimed in any one of claims 1 to 4, characterized in that the halogen atoms are chosen from bromine, chlorine and iodine.

6. The capsule as claimed in any one of claims 1 to 5, characterized in that the alkaline earth metal phosphates are chosen from mono-, di- or tricalcium phosphates, triphosphates or pyrophosphates.

7. The capsule as claimed in any one of claims 1 to 6, characterized in that the particles of the inorganic compound constituting the inorganic shell (E) have a size of between 0.1 and 100 microns, advantageously between 0.1 and 50 microns.

8. The capsule as claimed in any one of claims 1 to 7, characterized in that the shell (E) is composed of just one layer of particles of single inorganic compound.

9. The capsule as claimed in any one of claims 1 to 8, characterized in that the shell (E) represents between 0 exclusive and 50%, advantageously between 2 and 40% and preferably between 5 and 30%, by weight with respect to the total weight of the capsule.

10. The capsule as claimed in any one of the preceding claims, characterized in that the polyhydroxylated compound (P) is a polysaccharide which can be chosen from threose, erythrose, arabinose, xylose, ribose, deoxyribose, rhamnose, fucose, glucosamine, galactosamine, N-acetylglucosamine, N-acetylgalactosamine, starches, amylopectin, amylose, araban, alginates, carrageenans, cellulose, chitosan, chondroitin sulfate, dextran, dextrin, fructosan, galactan, galactomannans, gum arabic, pectins, gum ghatti, galactoside, glucan, glycan, glycogen, hemicellulose, hyaluronic [lacuna], inulin, lamarinarin, levan, mannan, mucoitin sulfate, nigeran, pentosan, polydextrose or xylan.

11. The capsule as claimed in any one of claims 1 to 10, characterized in that the particles of the compound (P) exhibit a size of between 1 to 500 microns, advantageously between 2 and 200 microns, preferably 2 and 80 microns.

12. The capsule as claimed in any one of claims 1 to 11, characterized in that the core (N) comprising at least one polyhydroxylated compound (P) represents between 50 and 100% exclusive, advantageously between 60 and 98% and preferably between 70 and 95%, by weight with respect to the total weight of the capsule.

13. The capsule as claimed in any one of the preceding claims, characterized in that the polyhydroxylated compound (P) is partially substituted by a substance (S) chosen from flavorings, essential oils, colorants, film-forming substances, such as depolymerized guar or arabinoxylan, or substances which prevent the formation of foams, such as polyethoxylated oils derived from palm oil, soybean oil, castor oil, rapeseed oil, corn oil or sunflower oil.

14. A process for the preparation, in the solid phase, of the capsule as claimed in any one of claims 1 to 13, characterized in that:
(i) a mixture of particles constituting the core (N) and that constituting the shell (E) is formed, said particles being in the solid state,
(ii) said mixture is subjected to impact forces with an impact rate of between 30 and 100 m/sec for a time which is sufficiently long for the particles constituting the shell (E) to cover the particles constituting the core (N),
(iii) the capsules (C) thus obtained are subsequently recovered.

15. The process as claimed in claim 14, characterized in that the ratio of the size of the particles constituting the shell (E) to that of the particles constituting the core (N) is at least ⅕, advantageously at least 1/10.

16. The process as claimed in either of claims 14 and 15, characterized in that the particles of the inorganic compound constituting the shell (E) exhibit a size of between 0.1 and 50 microns, advantageously between 0.1 and 10 microns and preferably between 0.1 and 5 microns.

17. The process as claimed in any one of claims 14 to 16, characterized in that the particles of the compound (P) and, if appropriate, of substance (S) constituting the core (N) exhibit a size of between 1 to 500 microns, advantageously between 2 and 200 microns, preferably 2 and 80 microns.

18. A capsule obtained by the process as defined in any one of claims 14 to 17.

19. The use of the capsule as claimed in any one of claims 1 to 13 or as claimed in claim 18 in the field of food, cosmetics, detergency, pharmaceuticals or construction.

20. A food formulation comprising the capsule as claimed in any one of claim 1 to 13.
